(19) United States
(12) Patent Application Publication
(10) Pub. No.: US 2007/0212032 A1
(43) Pub. Date: Sep. 13, 2007

(54) OPTICAL DISC, ACCESS APPARATUS AND ACCESS METHOD

(76) Inventor: Yasumori Hino, Nara (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/595,240

(22) PCT Filed: Sep. 29, 2004
(86) PCT No.: PCT/JP04/14708

§ 371 Date: Jan. 12, 2007

(30) Foreign Application Priority Data
Sep. 30, 2003 (JP) 2003-342108

(51) Int. Cl. H04N 5/00

(52) U.S. Cl. 386/126

(57) ABSTRACT

The optical disc of the present invention includes a plurality of areas which are previously allocated to correspond to a plurality of conditions. The plurality of areas include: at least one first area, which is previously allocated to correspond to at least one first condition under which the optical disc can be accessed, among the plurality of conditions; and at least one second area, which is previously allocated to correspond to at least one second condition under which the optical disc cannot be accessed, among the plurality of conditions. A plurality of first parameters for providing a method for accessing the optical disc under the at least one first condition are recorded on the at least one first area and the at least one second area.

### TECHNICAL FIELD

The present invention relates to an optical disc including a plurality of areas which are previously allocated to correspond to a plurality of conditions, an access apparatus for accessing the optical disc, and an access method for, accessing the optical disc.

### BACKGROUND ART

In recent years, an optical disc has been used very actively as a medium for an AV apparatus (audio visual apparatus) and a PC (personal computer). For example, a read-only CD-ROM for providing a program or application for the PC, a CD-R capable of additionally writing data and a CD-RW capable of rewriting data based on a CD (Compact Disc) developed for music, have been developed. A format for the CD-ROM, a format for the CD-R and a format for the CD-RW have been widely used in AV and PC fields.

In light of recent progress in high density technique, a read-only DVD (Digital Versatile Disc) format capable of storing a video of a movie or the like has been used rapidly. In the same manner as in the CD, additional writing type and rewriting type formats (for example, the format for the DVD-R, the format for the DVD-RAM, and the format for the DVD-RW) have been developed for the DVD so that the DVD has been used more rapidly.

In the technical field related to the optical disc, development for enhancing a transfer rate has been performed continuously. In a read-only apparatus, a transfer rate of approximately one times speed (×1 speed) to 48 times speed (×48 speed) has been realized. In a recordable optical disc, a transfer rate of approximately one times speed (×1 speed) to 16 times speed (×16 speed) has been realized. However, an increase in the transfer rate also causes demerits (e.g., an increase in the power consumption, an increase in the noise of a recording/reproduction apparatus with an increase in the rotating speed of the optical disc, and the like).

In view of merits and demerits which are generated by an increase in the transfer rate, an appropriate transfer rate is selected. For example, in a recording/reproduction apparatus of a portable type in which power is greatly limited, data is recorded or reproduced at a lower transfer rate during an operation performed by a battery and data is recorded or reproduced at a higher transfer rate during an operation performed by an AC adaptor attachment. In a case where power is not limited, the transfer rate is increased throughout the years. In recording/reproduction apparatuses which have already been put on the market, therefore, a transfer rate standardized when they were started to be put on the market should be considered as a maximum transfer rate. Accordingly, an optical disc utilized in the recording/reproduction apparatus is required to comply with all of the transfer rates from the past recording/reproduction apparatuses to the current recording/reproduction apparatuses.

In order to maintain a recording/reproduction performance at a plurality of transfer rates, a plurality of recording/reproduction parameters corresponding to the transfer rates are previously recorded on the optical disc. The recording/reproduction parameters are recorded in a lead-in area on a master disc during a fabricating process of the master disc, and are then recorded on the optical disc by transferring the parameters from the master disc onto the optical disc during a fabricating process of the substrate for the optical disc. For example, the recording/reproduction parameters are recorded in the form of a pit having a concavo-convex shape. Moreover, in some cases, the recording/reproduction parameters are recorded by wobbling a groove formed on the optical disc.

FIG. 8 shows a structure of a conventional optical disc 700 (for example, see Japanese Laid-Open Publication No. 1-201846, page 5 and FIG. 1)

The optical disc 700 includes a lead-in area 702, a data area 703 and a parameter recording area 704.

The data area 703 is an area in which user data is to be recorded. In the data area 703, a track including a continuous spiral groove Is formed.

The lead-in area 702 is an area in which information required for a system, such as control information for controlling the optical disc 700 and replacement information, is recorded. In the lead-in area 702, a concavo-convex recording pit, which is transferred during the fabricating process of the substrate for the optical disc 700, is formed.

The lead-in area 702 includes a parameter recording area 704. The parameter recording area 704 is an area in which the recording/reproduction parameter for the optical disc 700 is recorded. In the parameter recording area 704, the recording/reproduction parameters corresponding to various transfer rates are previously recorded.

FIG. 9 shows a structure of data recorded in the parameter recording area 704.

The parameter recording area 704 includes a plurality of reading units 801. The reading units 801 are usually correspond to sectors. The sector consists of data and a parity which is using the Read-Solomon product code. The sector is a unit on which error correction is performed during the reproduction. In the sectors 801, the recording/reproduction conditions of the transfer rates which are different from each other are recorded.

The parameter recording area 704 includes sectors 802 to 809. The sectors 802 to 809 are a plurality of areas which are previously allocated to correspond to a plurality of conditions. The sector 802 is an area which is previously allocated to correspond to a recording/reproduction condition for one times speed (×1 speed). The sector 803 is an area which is previously allocated to correspond to a recording/reproduction condition for two times speed (×2 speed). The sector 804 is an area which is previously allocated to correspond to a recording/reproduction condition for four times speed (×4 speed). The sector 805 is an area which is previously allocated to correspond to a recording/reproduction condition for eight times speed (×8 speed).

The recording/reproduction conditions for one times speed (×1 speed) to eight times speed (×8 speed) are recorded in the sectors 802 to 805, respectively. In the sector 802, a recording/reproduction parameter for one times speed (×1 speed) is recorded. In the sector 803, a recording/reproduction parameter for two times speed (×2 speed) is recorded. In the sector 804, a recording/reproduction parameter for four times speed (×4 speed) is recorded In the sector 805, a recording/reproduction parameter for eight times speed (×8 speed) is recorded.

The sectors 806 to 809 are reserved as areas for adding the recording/reproduction parameters in a case where the transfer rate or the recording/reproduction condition is changed in the future. In the future, an optical disc, in which the recording/reproduction parameters are added to the sectors 806 to 809, is produced and shipped in accordance with progress in a technique and development in standardization.

Various information (recording/reproduction parameters) which are varied depending on a recording/reproduction speed are recorded in the sectors 802 to 805.

In each of the sectors 802 to 805, information regarding a linear velocity for performing the recording/reproduction operation, information regarding a reproducing power for performing the reproduction operation, information regarding a recording power, information regarding a pulse waveform of a laser in performing the recording operation, information required for determining a recording power through optimizing process using a recording characteristic by the recording/reproduction apparatus and the like are recorded as the recording/reproduction parameters corresponding to the respective transfer rates. These information are generally used as parameters required for performing the recording/reproduction operation. Further various information required for performing the recording/reproduction operations may be recorded on many optical discs in order to optimize the state of the recording/reproduction state.

Firstly, an apparatus using the optical disc 700 reads the information recorded in the lead-in area 702 and determines whether or not the optical disc 700 can be handled, based on this information. When the optical disc 700 can be handled, the apparatus sets the apparatus to an appropriate state by referring to the information recorded on the lead-in area 702.

Secondly, the apparatus reads the recording/reproduction parameter for performing the recording/reproduction operation for the optical disc 700 under the recording/reproduction condition corresponding to a speed which can be handled by the apparatus, from the parameter recording area 704, and performs an operation such as an optimizing process for recording/reproduction by referring to the recording/reproduction parameter. Then, the apparatus performs the recording/reproduction operation for the optical disc 700.

By these operations, the recording/reproduction operation can be performed in an appropriate operation state corresponding to the optical disc even in a case where the recording/reproduction conditions, such as speed and transfer rate, are varied. As a result, it is possible to stably perform recording/reproduction operation for a wide range of recording/reproduction speeds.

With an increase in the recording/reproduction transfer rate, however, the combination of the optical disc and the recording/reproduction speed of the recording/reproduction apparatus is very complicated. For example, the number of combinations of a transfer rate available for the optical disc and a transfer rate available for the recording/reproduction apparatus is increased, making it very difficult to read an optimum recording/reproduction parameter at a high speed in as few steps possible by the recording/reproduction apparatus. As a result, it is necessary to read the complicated recording/reproduction conditions when the optical disc is inserted into the recording/reproduction apparatus. This causes a problem that the time required for initiating the recording/reproduction apparatus is increased. Further, this causes another problem that the time required for initiating the recording/reproduction apparatus is varied depending on the combination of the optical disc and the recording/reproduction apparatus.

These problems will be described below in more detail.

FIG. 10 shows a structures of parameter recording areas of a plurality of optical discs corresponding to various recording/reproduction speeds.

An optical disc 901 corresponds to recording/reproduction operations at one times speed (×1 speed) to two times speed (×2 speed). In the sector 802, a recording/reproduction parameter for one times speed (×1 speed) is recorded In the sector 803, a recording/reproduction parameter for two times speed (×2 speed) is recorded. In the sectors 804 to 809, any recording/reproduction parameter is not recorded.

An optical disc 902 corresponds to recording/reproduction operations at one times speed (×1 speed) to eight times speed (×8 speed). In the sector 802, a recording/reproduction parameter for one times speed (×1 speed) is recorded. In the sector 803, a recording/reproduction parameter for two times speed (×2 speed) is recorded. In the sector 804, a recording/reproduction parameter for four times speed (×4 speed) is recorded. In the sector 805, a recording/reproduction parameter for eight times speed (×8 speed) is recorded. In the sectors 806 to 809, no recording/reproduction parameter is recorded.

An optical disc 903 corresponds to recording/reproduction operations at two times speed (×2 speed) to 16 times speed (×16 speed). In the sector 803, a recording/reproduction parameter for two times speed (×2 speed) is recorded. In the sector 804, a recording/reproduction parameter for four times speed (×4 speed) is recorded. In the sector 805, a recording/reproduction parameter for eight times speed (×8 speed) is recorded. In the sector 806, a recording/reproduction parameter for 16 times speed (×16 speed) is recorded. In the sectors 802 and 807 to 809, no recording/reproduction parameter is recorded.

Hereinafter, a case where a recording/reproduction apparatus corresponding to one times speed (×1 speed) to two times speed (×2 speed) performs a recording/reproduction operation for the optical discs 901 to 903 will be described.

For example, in a case where the recording/reproduction apparatus corresponding to the one times speed (×1 speed) to two times speed (×2 speed) performs a recording/reproduction operation at two times speed (×2 speed), it reads a recording/reproduction parameter for two times speed (×2 speed) recorded in the sector 803. In this case, a recording/reproduction condition is recorded in the respective sectors 803 of the optical discs 901 to 903, and the recording/reproduction apparatus can obtain the recording/reproduction condition by simply reading the sector 803 once.

A case where the optical discs 901 to 903 are inserted in order to perform the recording/reproduction operation at 16 times speed (×16 speed) by means of the recording/reproduction apparatus corresponding to the one times speed (×1 speed) to 16 times speed (×16 speed) will be described. In this case, the recording/reproduction apparatus reads information recorded in the sector 806. For example, the sector 806 of the optical disc 903 is read. In this case, the recording/reproduction operation can be performed up to 16 times speed (×16 speed) for the optical disc 903. The recording condition is recorded in the sector 806. The recording/reproduction operation can be performed at 16 times speed (×16 speed) by referring to the recording/reproduction parameter which can be obtained by reading the sector 806. However, in the sector 806 of the optical disc 901 and the sector 806 of the optical disc 902, no recording/reproduction condition is recorded. Therefore, it is not possible to set an appropriate recording/reproduction condition based on the data which can be obtained by reading the sector 806. Even in this case, the recording/reproduction apparatus into which the optical disc is inserted can perform the recording/reproduction operation at one times speed (×1 speed) to 16 times speed (×16 speed). Therefore, it is possible to perform the recording/reproduction operation for the optical discs 901 and 902. However, it is necessary to read the recording/reproduction condition available for the inserted optical disc again, in order for the recording/reproduction apparatus to perform the recording/reproduction operation at a speed available for the inserted the optical disc.

In the example described with reference to FIG. 8, it is necessary to read the sector 803 or the sector 802 of the optical disc 901 again, or it is necessary to read any one of the sectors 802 to 805 of the optical disc 902 again.

In a combination of an optical disc, in which data can be recorded at a plurality of transfer rates, and an apparatus capable of performing the recording/reproduction operation at a plurality of transfer rates, a case where an appropriate recording/reproduction condition cannot be read by a single reading operation is created. This causes an increase in the time required for initiating a drive.

The present invention is made in view of the problems described above. One of the purposes of the present invention is to provide an optical disc including a plurality of areas which are previously allocated to correspond to a plurality of conditions, an access apparatus for accessing the optical disc and an access method for accessing the optical disc.

### DISCLOSURE OF THE INVENTION

The optical disc of the present invention is an optical disc including a plurality of areas which are previously allocated to correspond to a plurality of conditions, wherein the plurality of areas include: at least one first area, which is previously allocated to correspond to at least one first condition under which the optical disc can be accessed, among the plurality of conditions; and at least one second area, which is previously allocated to correspond to at least one second condition under which the optical disc cannot be accessed, among the plurality of conditions, and a plurality of first parameters for providing a method for accessing the optical disc under the at least one first condition are recorded on the at least one first area and the at least one second areas thereby achieving the purpose of the invention described above.

One of the plurality of the first parameters corresponding to each of the at least one first area may be recorded on each of the at least one first area.

One of the plurality of first parameters which is closest in value to a plurality of second parameters for providing a method for accessing the optical disc under the at least one second condition may be recorded on the at least one second area.

The optical disc includes at least one recording layer, each of the at least one recording layer include the at least one first area and the at least one second area, and a plurality of third parameters for providing a method for accessing each of the at least one recording layer under the at least one first condition may be recorded on the at least one first area and the at least one second area.

The plurality of conditions may include a condition regarding a speed at which the optical disc is accessed.

The access apparatus of the present invention is an access apparatus for accessing an optical disc including a plurality of areas which are previously allocated to correspond to a plurality of conditions, wherein the plurality of areas include at least one first area, which is previously allocated to correspond to at least one first condition under which the optical disc can be accessed, among the plurality of conditions, and at least one second area, which is previously allocated to correspond to at least one second condition under which the optical disc cannot be accessed, among the plurality of conditions, and a plurality of first parameters for providing a method for accessing the optical disc under the at least one first condition are recorded on the at least one first area and the at least one second area, the access apparatus including: a reading section for reading at least one of the plurality of first parameters from at least one of the at least one first area and the at least one second area; and an access section for accessing the optical discussing an accessing method provided by the read at least one first parameter, thereby achieving the purpose of the invention described above.

The reading section may read the at least one first parameter from at least one of the at least one second area.

The access method of the present invention is an access method of accessing an optical disc including a plurality of areas which are previously allocated to correspond to a plurality of conditions, wherein the plurality of areas include at least one first area, which is previously allocated to correspond to at least one first condition under which the optical disc can be accessed, among the plurality of conditions, and at least one second area, which is previously allocated to correspond to at least one second condition under which the optical disc cannot be accessed, among the plurality of conditions, and a plurality of first parameters for providing a method for accessing the optical disc under the at least one first condition are recorded on the at least one first area and the at least one second area, the access method including the steps of: reading at least one of the first parameters from at least one of the at least one first area and the at least one second area; and accessing the optical disc using an access method provided by the read at least one first parameter, thereby achieving the purpose of the invention described above.

### BRIEF DESCRIPTION OF THE DRAWINGS

FIG. 1 is a view showing an optical disc 101 according to an embodiment of the present invention.

FIG. 2 is a view for explaining a process for fabricating a master disc of the optical disc 101.

FIG. 3 is a view for explaining a process for fabricating the optical disc 101.

FIG. 4 is a diagram showing a data structure of a parameter recording area 104 of the optical disc 101 according to an embodiment of the present invention.

FIG. 5 is a diagram showing the details of a recording/reproduction parameter.

FIG. 6 is a diagram showing a structure of a recording/reproduction apparatus 600 according to an embodiment of the present invention.

FIG. 7 is a flowchart showing a recording/reproduction procedure according to an embodiment of the present invention.

FIG. 8 is a view showing a structure of a conventional optical disc 700.

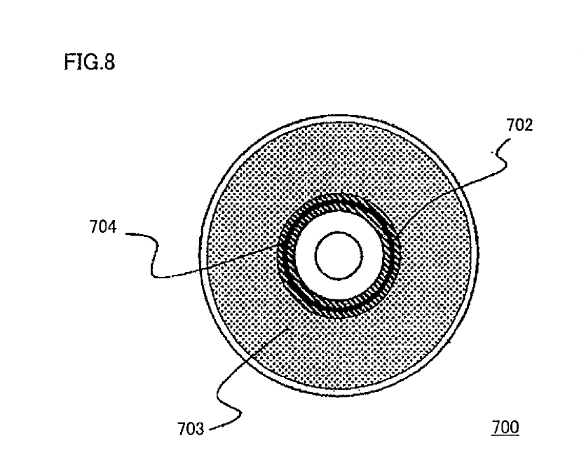

FIG. 9 is a diagram showing a structure of data recorded on a parameter recording area 704.

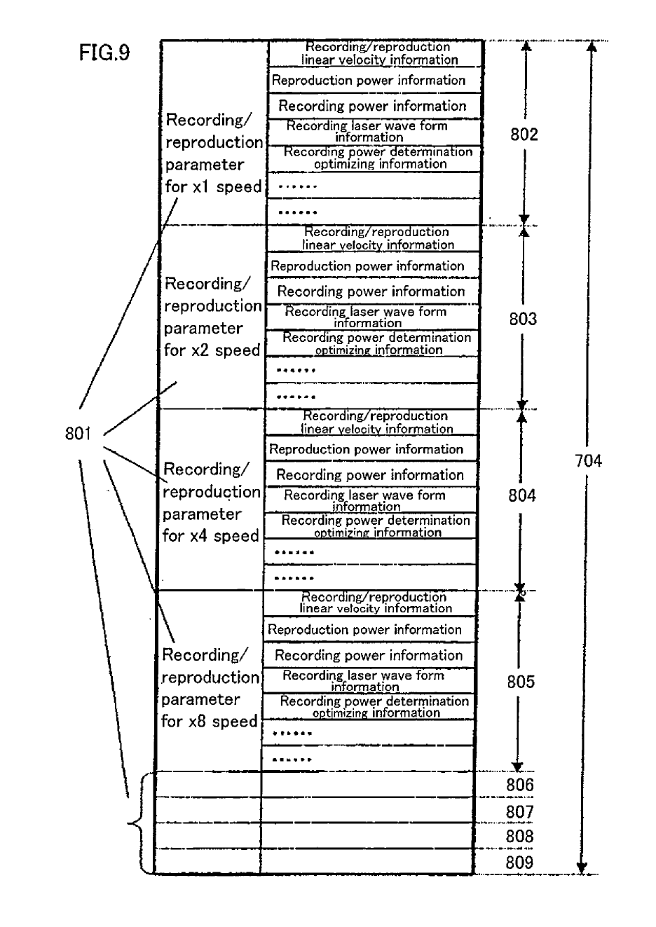

FIG. 10 is a diagram showing the structures of parameter recording areas of optical discs corresponding to various recording/reproduction speeds.

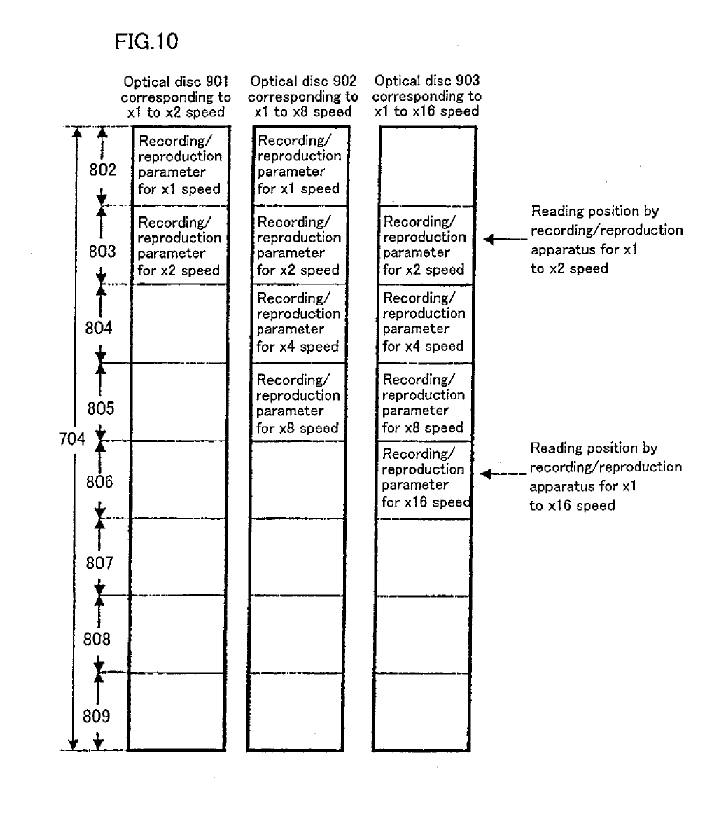

### BEST MODE FOR CARRYING OUT THE INVENTION

Hereinafter, embodiments of the present invention will be described below with reference to the drawings.

In an embodiment of the present invention, firstly, an optical disc including a plurality of areas which is previously allocated corresponding to a plurality of conditions will be described (see ‘1. Optical disc’). Secondly, a method for fabricating an optical disc (steps for fabricating a master disc and steps for fabricating a disc) will be described (see “1. Optical disc”). Thirdly, recording/reproduction parameters recorded on a plurality of areas of the optical disc will be described (see “1. Optical disc”). Fourthly, a recording/reproduction apparatus and a recording/reproduction method for setting a recording/reproduction parameter to perform a recording/reproduction operation based on a recording/reproduction condition will be described (see “2. Recording/reproduction apparatus” and “3. Recording/reproduction method”).

### 1. Optical Disc

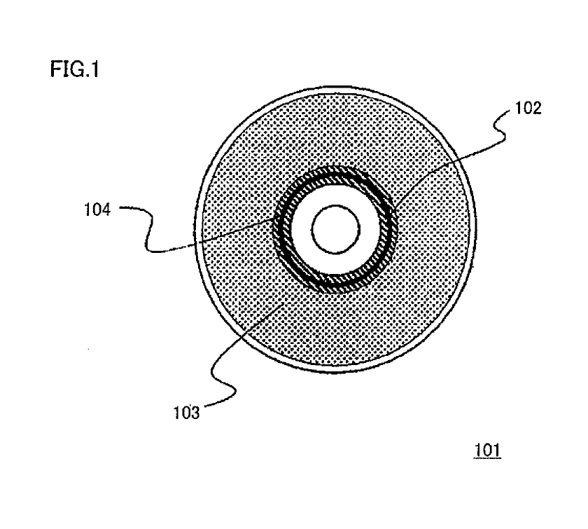

FIG. 1 shows an optical disc 101 according to an embodiment of the present invention.

The optical disc 101 includes a recording film of a phase-change type. The optical disc 101 has a diameter of 50 mm, an inside diameter of 11 mm and a thickness of 0.8 mm, for example. Information is recorded or reproduced through a transparent substrate having a thickness of 0.1 mm by means of an optical head (a wavelength of an irradiated light of 405 nm and a numerical aperture (NA) of 0.85).

The optical disc 101 includes two recording layers. The optical disc 101 includes a lead-in area 102, a data area 103 and a parameter recording area 104.

The lead-in area 102 is an area on which information required for a system, such as control information for controlling the optical disc 101, and replacement information are recorded. By wobbling a groove transferred during a process for fabricating the substrate of the optical disc 101, information is previously recorded on the lead-in area 102.

The lead-in area 102 includes the parameter recording area 104 The parameter recording area 104 serves to record the recording/reproduction parameter of the optical disc 101. The recording/reproduction parameters corresponding to various transfer rates are previously recorded in the parameter recording area 104.

The lead-in area 102 includes an area on which information required for a system to perform the recording/reproduction operation for the optical disc 101 is recorded, such as an area on which control information for is controlling a recording power and a recording pulse timing of the optical disc 101 are previously recorded by the wobbling of a groove, and a test area for optimizing a recording power.

In the lead-in area 102, a track pitch is wider than that in the data area 103 in order to stably read the control information recorded by the wobbling of the groove.

In the optical disc 101, the data area 103 has a radius of 23.8 mm to 12.25 mm and the lead-in area 102 has a radius of 12.25 mm to 11.75 mm and a width of 0.5 mm measured toward an inner periphery from radius of 12.25 mm.

In the lead-in area 102 and the data recording area 103, a track is formed into a continuous spiral shape. The lead-in area 102 has a track pitch (an interval between the grooves) of 0.35 μm and the data area 103 has a track pitch of 0.32 μm. On a boundary between the lead-in area 102 and the data area 103, the track pitch is changed continuously to be within a range of approximately 30 μm. An address for providing an access is recorded in a track by the wobbling of the groove.

The data area 103 is an area on which rewritable recording data is to be recorded. The rewritable recording data is recorded as an amorphous recording pit in the groove in the data area 103. The recording pit is formed in the data area 103 by the same method as that used in a rewritable DVD or the like. For example, the recording pit is formed in the data area 103 by modulating an intensity of a recording laser beam with a multi-pulse and quenching a recording film.

The optical disc 101 according to the embodiment of the present invention has been described above with reference to FIG. 1. The optical disc 101 is only an example of the optical disc (optical recording medium) according to the present invention and the present invention is not limited to this example.

Hereinafter, a process for fabricating the optical disc 101 according to an embodiment of the present invention will be described.

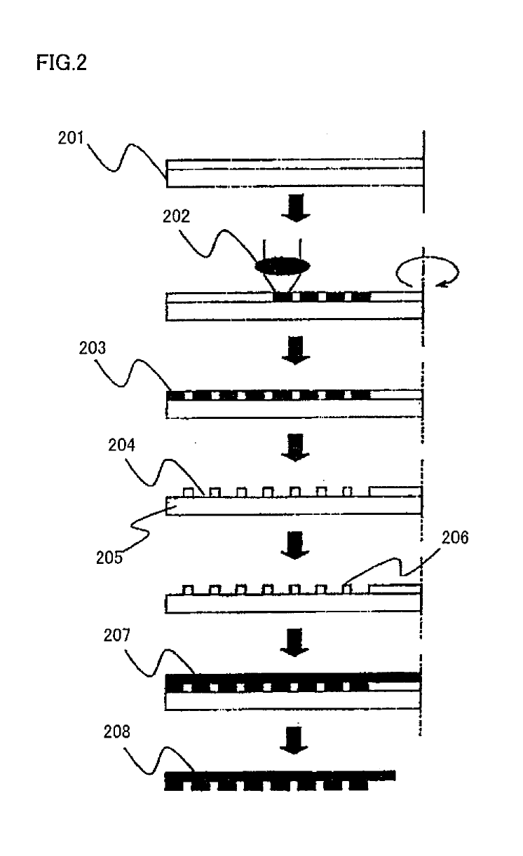

FIG. 2 is a view for explaining a process for fabricating a master disc of the optical disc 101.

A glass plate 201 having a positive photoresist applied uniformly as a photosensitive material is prepared. A desired groove pattern is exposed by means of a cutting machine 202 using a vacuum ultraviolet laser having a wavelength of 248 nm. At this time, the cutting machine 202 wobbles a light beam based on a signal sent from a formatter and records an address and control information in a part of the lead-in area 102. A track pitch is changed by varying the amount of feed of the cutting machine 202 between the lead-in area 102 and the data area 103. When an outermost periphery of the data area 103 is reached, the exposure is completed.

By the process described above, a latent image 203 having a desired groove pattern is recorded in the glass plate 201. By performing development and drying while rotating the glass plate 201, a master disc 205 having a groove pattern 204 formed thereon is fabricated. A nickel film 206 is formed on the master disc 205 by a sputtering method and is set to be an electrode, thereby performing nickel plating Thus, a thin plate 207 formed of nickel is fabricated. The thin plate 207 is peeled and the resist is removed to polish a back face and to then punch the back face to have a desired shape. Thus, a stamper 208 is fabricated. During this process, when the lead-in area 102 is to be exposed, the information is modulated. As a result, control information for controlling the optical disc 101 and recording/reproduction parameters corresponding to various recording speeds are recorded.

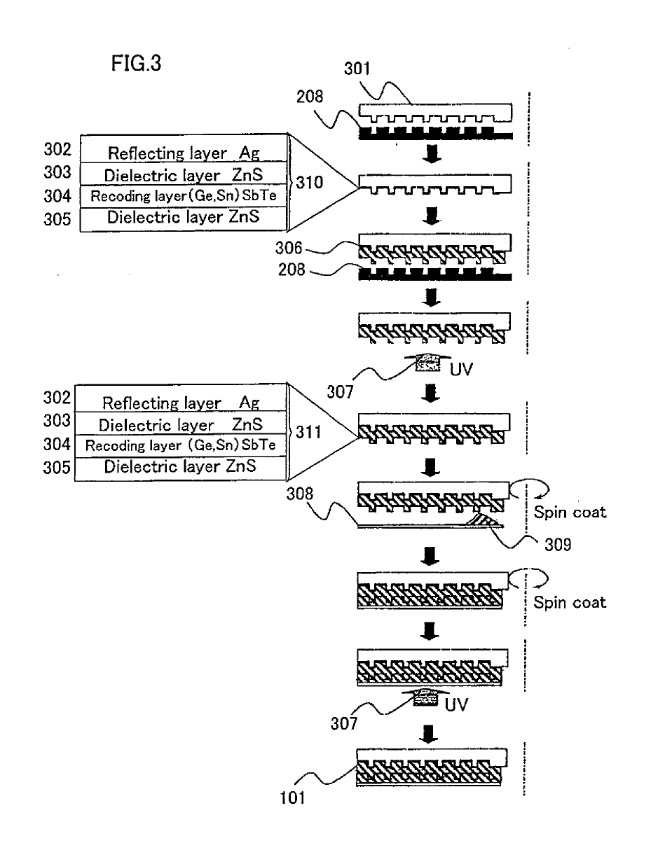

FIG. 3 is a view for explaining a process for fabricating the optical disc 101.

The stamper 208 fabricated by the method described with reference to FIG. 2 is attached to an injection molding machine, and injection molding using polycarbonate as a material is performed to fabricate a molding substrate 301 having a thickness of 0.7 mm. The shape of the groove of the stamper 208 is transferred into the molding substrate 301. An Ag reflecting layer 302 having a thickness of 80 nm, a ZnS dielectric layer 303 having a thickness of 20 nm, a (Ge, Sn) SbTe recording layer 304 having a thickness of 10 nm, and a ZnS dielectric layer 305 having a thickness of 57 nm are laminated by the sputtering method on a surface of the substrate 301 into which the groove is transferred. Thus, a first recording layer 310 is obtained.

Furthermore, an ultraviolet curing resin 306 is dropped thereto to transfer the groove of the stamper 208. The ultraviolet curing resin 306 is cured by an ultraviolet ray 307. The ZnS dielectric layer 303 having a thickness of 20 nm, the (Ge, Sn) SbTe recording layer 304 having a thickness of 10 nm, and the ZnS dielectric layer 305 having a thickness of 57 nm are laminated by the sputtering method on a surface of the cured ultraviolet curing resin 306 into which the groove is transferred. Thus, a second recording layer 311 is obtained.

Next, a polycarbonate sheet 309 having a thickness of approximately 90 μm to which the ultraviolet curing resin 308 over a spin coater is superposed onto the dielectric layer 305 and the spin coater is then rotated to take away the residual ultraviolet curing resin. When the thickness of the ultraviolet curing resin 308 becomes approximately 10 μm, the rotation of the spin coater is stopped and the ultraviolet ray 307 is irradiated by an ultraviolet source to cure the ultraviolet curing resin 308.

The entire surface of the recording layer 304 of the optical disc 101 is amorphous in a state where it is formed by the sputtering method, and a crystallization treatment for the recording layer 304 which is generally referred to as an initializing process is required. The crystallization treatment is usually performed by scanning the entire surface with a uniform light in an initializing apparatus mounting a high power laser beam having a wavelength of approximately 650 nm. By this treatment, a reflectance of the recording film 304 is approximately 20%.

Thus, the method of fabricating the optical disc 101 according to an embodiment of the present invention has been described with reference to FIGS. 2 and 3.

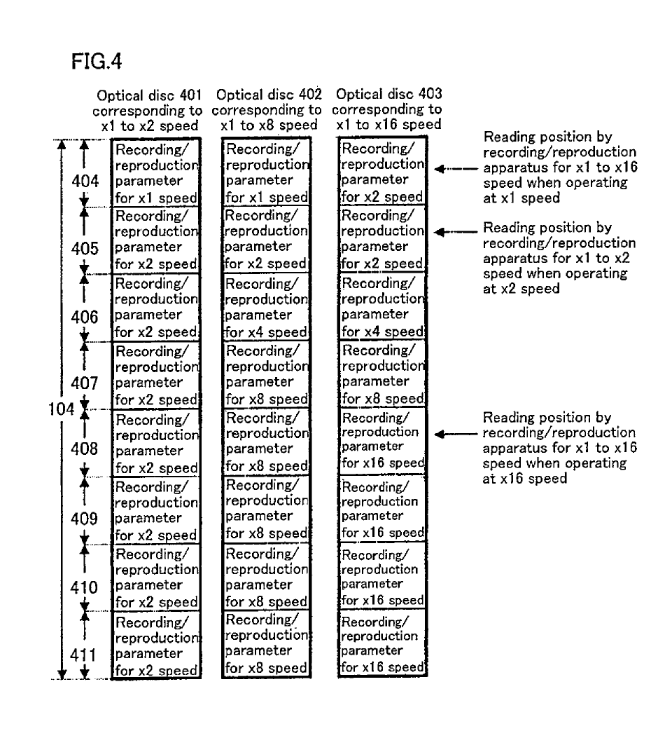

FIG. 4 shows a data structure of the parameter recording area 104 of the optical disc 101 according to an embodiment of the present invention.

In the parameter recording area 104 of the optical disc 101, sectors 404 to 411 are previously allocated to correspond to a plurality of conditions (e.g., recording/reproduction conditions for the one times speed (×1 speed), two times speed (×2 speed), four times speed (×4 speed), eight times speed (×8 speed), 16 times speed (×16 speed), 32 times speed (×32 speed), 48 times speed (×48 speed) and 60 times speed (×64 speed)). A read error correction can be simultaneously performed for the sectors 404 to 411.

The optical disc 101 is, for example, an optical disc 401 corresponding to the recording/reproduction operations for one times speed (×1 speed) to two times speed (×2 speed).

In the parameter recording area 104 of the optical disc 401, sectors 404 and 405 are previously allocated to correspond to the conditions under which the optical disc 401 can be accessed (e.g., recording/reproduction conditions for one times speed (×1 speed) and two times speed (×2 speed)).

In the parameter recording area 104 of the optical disc 401, sectors 406 to 411 are previously allocated to correspond to the conditions under which the optical disc 401 cannot be accessed (e.g., recording/reproduction conditions for four times speed (×4 speed), eight times speed (×8 speed), 16 times speed (×16 speed), 32 times speed (×32 speed), 48 times speed (×48 speed) and 60 times speed (×60 speed)).

In the sectors 404 to 411 of the optical disc 401, recording/reproduction parameters for performing the recording/reproduction operation for the optical disc 401 under the conditions that the optical disc 401 can be accessed (e.g., recording/reproduction conditions for one times speed (×1 speed) and two times speed (×2 speed)) are recorded.

In each of the sectors 404 and 405 of the optical disc 401, one recording/reproduction parameter corresponding to each of the sectors 404 and 405 is recorded.

In the sectors 406 to 411 of the optical disc 401, recording/reproduction parameters, for performing the recording/reproduction operation for the optical disc 401 under the condition which is closest in value to the conditions that the optical disc 401 cannot be accessed (e.g., recording/reproduction conditions for four times speed (×4 speed), eight times speed (×8 speed), 16 times speed (×16 speed), 32 times speed (×32 speed), 48 times speed (×48 speed) and 60 times speed (×60 speed)), among the recording/reproduction parameters for performing the recording/reproduction operation for the optical disc 401 under the conditions that the optical disc 401 can be accessed (e.g., recording/reproduction conditions for one times speed (×1 speed) and two times speed (×2 speed)), are recorded.

For example, the recording/reproduction parameter for one times speed (×1 speed) is recorded in the sector 404 of the optical disc 401. The recording/reproduction parameter for two times speed (×2 speed) is recorded in the sectors 405 to 411.

The optical disc 101 is, for example, an optical disc 402 corresponding to the recording/reproduction operations for one times speed (×1 speed) to eight times speed (×8 speed)

In the parameter recording area 104 of the optical disc 402, sectors 404 to 407 are previously allocated to correspond to the conditions under which the optical disc 402 can be accessed (e.g., recording/reproduction conditions for one times speed (×1 speed), two times speed (×2 speed), four times speed (×4 speed) and eight times speed (×8 speed)).

In the parameter recording area 104 of the optical disc 402, sectors 408 to 411 are previously allocated to correspond to the conditions under which the optical disc 402 cannot be accessed (e.g., recording/reproduction conditions for four times speed (×4 speed), eight times speed (×8 speed), 16 times speed (×16 speed), 32 times speed (×32 speed), 48 times speed (×48 speed) and 60 times speed (×60 speed)).

In the sectors 404 to 411 of the optical disc 402, recording/reproduction parameters, for performing the recording/reproduction operation for the optical disc 402 under the conditions that the optical disc 402 can be accessed (e.g., recording/reproduction conditions for one times speed (×1 speed), two times speed (×2 speed), four times speed (×4 speed) and eight times speed (×8 speed)), are recorded.

In each of the sectors 404 and 407 of the optical disc 402, one recording/reproduction parameter, corresponding to each of the sectors 404 and 407, among the recording/reproduction parameters for performing the recording/reproduction operation for the optical disc 402 under the condition that the optical disc 402 can be accessed (e.g., recording/reproduction conditions for one times speed (×1 speed), two times speed (×2 speed), four times speed (×4 speed) and eight times speed (×8 speed)), is recorded.

In the sectors 408 to 411 of the optical disc 402, recording/reproduction parameters, for performing the recording/reproduction operation for the optical disc 402 under the condition (e.g., recording/reproduction condition for eight times speed (×8 speed)) which is closest in value to the conditions that the optical disc 402 cannot be accessed (e.g., recording/reproduction conditions for 16 times speed (×16 speed), 32 times speed (×32 speed), 48 times speed (×48 speed) and 60 times speed (×60 speed)), among the recording/reproduction parameters for performing the recording/reproduction operation for the optical disc 402 under the conditions that the optical disc 402 can be accessed (e.g., recording/reproduction conditions for one times speed (×1 speed), two times speed (×2 speed), four times speed (×4 speed) and eight times speed (×8 speed)), are recorded.

For example, the recording/reproduction parameter for one times speed (×1 speed) is recorded in the sector 404 of the optical disc 402. The recording/reproduction parameter for two times speed (×2 speed) is recorded in the sectors 405 of the optical disc 402. The recording/reproduction parameter for four times speed (×4 speed) is recorded in the sector 406 of the optical disc 402. The recording/reproduction parameter for eight times speed (×8 speed) is recorded in the sector 407 of the optical disc 402. The recording/reproduction parameter for eight times speed (×8 speed) is recorded in the sectors 408 to 411.

The optical disc 101 is, for example, an optical disc 403 corresponding to the recording/reproduction operations for two times speed (×2 speed) to 16 times speed (×16 speed).

In the parameter recording area 104 of the optical disc 403, sectors 405 to 408 are previously allocated to correspond to the conditions under which the optical disc 403 can be accessed (e.g., recording/reproduction conditions for two times speed (×2 speed), four times speed (×4 speed), eight times speed (×8 speed) and 16 times speed (×16 speed).

In the parameter recording area 104 of the optical disc 403, sector 404 and sectors 409 to 411 are previously allocated to correspond to the conditions under which the optical disc 403 cannot be accessed (e.g., recording/reproduction conditions for one times speed (×1 speed), 32 times speed (×32 speed), 48 times speed (×48 speed) and 60 times speed (×60 speed)).

In the sectors 404 to 411 of the optical disc 403, recording/reproduction parameters, for performing the recording/reproduction operation for the optical disc 403 under the conditions that the optical disc 403 can be accessed (e.g., recording/reproduction conditions for two times speed (×2 speed), four times speed (×4 speed), eight times speed (×8 speed) and 16 times speed (×16 speed)), are recorded.

In each of the sectors 405 and 408 of the optical disc 403, one recording/reproduction parameter corresponding to each of the sectors 405 and 408, among the recording/reproduction parameters for performing the recording/reproduction operation for the optical disc 403 under the condition that the optical disc 403 can be accessed (e.g., recording/reproduction conditions for two times speed (×2 speed), four times speed (×4 speed) and eight times speed (×8 speed) and 16 times speed (×16 speed)), is recorded.

In the sector 404 and the sectors 409 to 411 of the optical disc 403, recording/reproduction parameters, for performing the recording/reproduction operation for the optical disc 403 under the condition (e.g., recording/reproduction condition for two times speed (×2 speed) or recording/reproduction condition for 16 times speed (×16 speed)), which is closest in value to the conditions that the optical disc 403 cannot be accessed (e.g., recording/reproduction conditions for one times speed (×1 speed), 32 times speed (×32 speed), 48 times speed (×48 speed) and 60 times speed (×60 speed)), among the recording/reproduction parameters for performing the recording/reproduction operation for the optical disc 403 under the conditions that the optical disc 403 can be accessed (e.g., recording/reproduction conditions for two times speed (×2 speed), four times speed (×4 speed), eight times speed (×8 speed) and 16 times speed (×16 speed)), are recorded.

For example, the recording/reproduction parameter for two times speed (×2 speed) is recorded in the sector 404 of the optical disc 403. The recording/reproduction parameter for two times speed (×2 speed) is recorded in the sectors 405 of the optical disc 403. The recording/reproduction parameter for four times speed (×4 speed) is recorded in the sector 406 of the optical disc 403. The recording/reproduction parameter for eight times speed (×8 speed) is recorded in the sector 407 of the optical disc 403. The recording/reproduction parameter for 16 times speed (×16 speed) is recorded in the sectors 408 to 411.

As described above with reference to FIG. 4, the optical discs 401 to 403 include the sectors 404 to 411 which is are previously allocated to correspond to the recording/reproduction conditions. In a case where the optical discs 401 to 403 do not correspond to a predetermined recording/reproduction condition, in the sector which is previously allocated to correspond to the predetermined recording/reproduction condition, the recording/reproduction parameter, for performing the recording/reproduction operation for the optical disc under the condition which is closest in value to the conditions that the optical disc cannot be accessed (e.g., the predetermined recording/reproduction condition), among the recording/reproduction parameters for performing the recording/reproduction operation for the optical disc under the conditions that the optical disc can be accessed, is recorded. Accordingly, it is possible to always keep the time required fox reading the recording/reproduction conditions constant by combining an optical disc capable of performing the recording operation at a plurality of transfer rates and an apparatus capable of performing the recording/reproduction operation at a plurality of transfer rates.

In the case where the optical discs 401 to 403 do not correspond to a predetermined recording/reproduction conditions, it is not limited that the recording/reproduction parameter for performing the recording/reproduction operation for the optical disc under the condition which is closest in value to the predetermined recording/reproduction condition is recorded in the sector which is previously allocated to correspond to the predetermined recording/reproduction condition. As long as the recording/reproduction parameter for performing the recording/reproduction operation for the optical disc under the condition that the optical disc can be accessed is recorded in the sectors 404 to 411, any recording/reproduction parameter can be recorded.

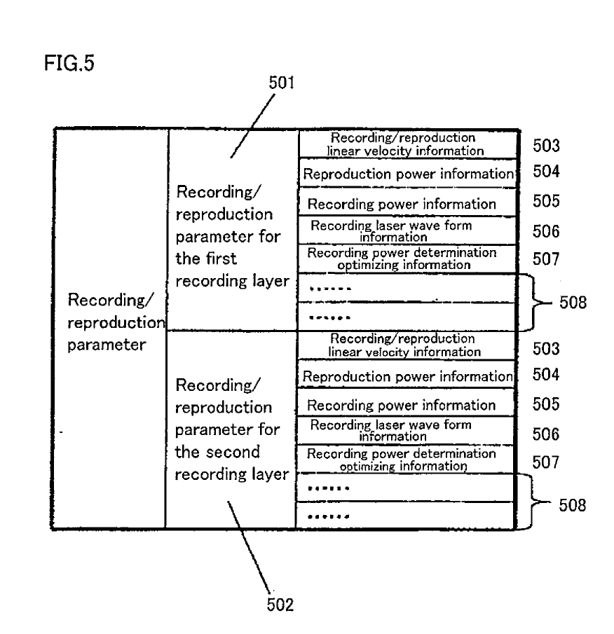

FIG. 5 shows the details of the recording/reproduction parameter.

The optical disc 101 includes a first recording layer 310 and a second recording layer 311 (see FIG. 3). Each of the first recording layer 310 and the second recording layer 311 includes a plurality of sectors which is previously allocated to correspond to a plurality of conditions. In the plurality of sectors, a plurality of recording/reproduction parameters for providing a method for performing the recording/reproduction operation for each of the first recording layer 310 and the second recording layer 311 under a predetermined condition are recorded. For example, the recording/reproduction parameter includes a recording/reproduction parameter 501 for the first recording layer 310 and a recording/reproduction parameter 502 for the second recording layer 311.

The recording/reproduction parameter 501 and the recording/reproduction parameter 502 are required for performing the recording/reproduction operation for each of the first recording layer 310 and the second recording layer 311 at the same speed. By recording the recording/reproduction parameters required for performing the recording/reproduction operation at the same speed in one sector (e.g., one reproduction unit), it is possible to obtain an effect that the recording/reproduction condition of each layer can be read by a single reading operation.

Each of the recording/reproduction parameter 501 and the recording/reproduction parameter 502 includes linear velocity information 503 for performing the recording/reproduction operation, reproduction power information 504 for performing the reproduction operation, information 505 regarding a recording power, information 506 regarding a pulse waveform of a laser in performing the recording operation, and information 507 required for determining a recording power through optimizing process using a recording characteristic by the recording/reproduction apparatus. Further, it includes reserve information 508 reserved for possible enhancement in the future.

Thus, the optical discs according to the present invention have been described above with reference to FIGS. 1 to 5.

In an embodiment according to the present invention, the optical disc 101 has a circular shape, for example. A track is formed on the circular optical disc. The track has a spiral shape or a concentrically circular shape, for example.

Furthermore, the optical disc according to the present invention is an example of a recording medium including a plurality of areas which are previously allocated to correspond to a plurality of conditions.

In an embodiment according to the present invention, a case where the recording/reproduction condition relates to a transfer rate for recording or reproducing data with respect to the optical disc. However, the scope of the present invention is not limited to the case where the recording/reproduction condition relates to a transfer rate for recording or reproducing data with respect to the optical disc. As long as the recording/reproduction condition relates to a transfer rate for accessing the optical disc, any transfer rate can be used.

For example, in addition to a case where a transfer rate for recording and reproducing the data with respect to the optical disc, a case where a transfer rate for recording data on the optical disc and a case where a transfer rate for reproducing data from the optical disc should also be included within the scope of the present invention.

According to the optical disc according to the present invention, in at least one second area which is previously allocated to correspond to at least one second condition under which the optical disc cannot be accessed, a plurality of first parameters for providing a method for accessing the optical disc under at least one first condition that the optical disc can be accessed. In this case, when an access apparatus (e.g., a recording/reproduction apparatus) accesses the second area, the access apparatus can obtain the first parameter from the second area, without moving from the second area to the first area to obtain the first parameter in the first area. As a result, the access apparatus can obtain the first parameter in a short amount of time.

### 2. Recording/Reproduction Apparatus

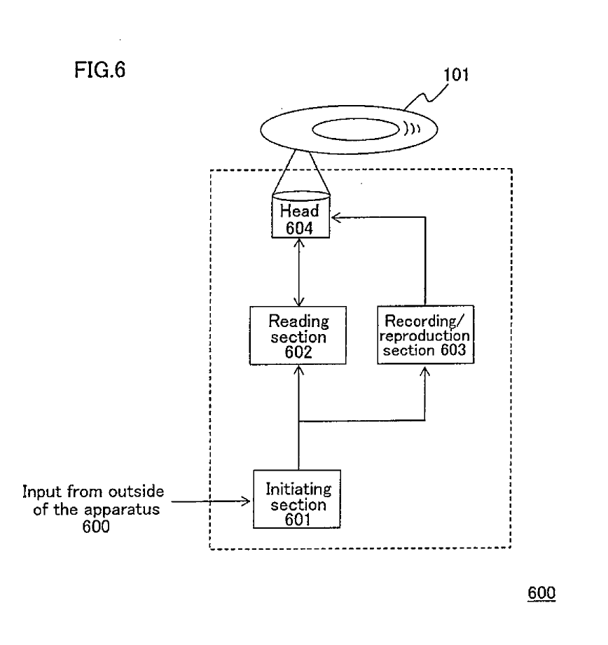

FIG. 6 shows a structure of a recording/reproduction apparatus 600 according to an embodiment of the present invention.

Hereinafter, the structure of the recording/reproduction apparatus 600 according to an embodiment of the present invention will be described with reference to FIGS. 4 and 6.

The recording/reproduction apparatus 600 performs a recording operation or a reproduction operation for an optical disc including a plurality of sectors which are previously allocated to correspond to a plurality of conditions. The optical disc is, for example, an optical disc 101 according to an embodiment of the present invention.

The recording/reproduction apparatus 600 is configured such that the optical disc 101 can be inserted into the recording/reproduction apparatus 600. The recording/reproduction apparatus 600 includes an initiating section 601, a reading section 602, a recording/reproduction section 603 and a head 604.

The initiating section 601 initiates the recording/reproduction apparatus 600 in response to an input from the outside of the recording/reproduction apparatus 600.

The reading section 602 reads at least one of a plurality of recording/reproduction parameters from any of the sectors 404 to 411 included in the optical disc 101 which is previously allocated to correspond to a maximum performance condition indicating a maximum performance of the recording/reproduction apparatus 600 in response to the initiation of the recording/reproduction apparatus 600.

For example, it is assumed that the recording/reproduction apparatus 600 corresponds to the one times speed (×1 speed) to 16 times speed (×16 speed) and the optical disc 101 corresponds to the one times speed (×1 speed) to eight times speed (×8 speed). In this case, in response to the initiation of the recording/reproduction apparatus 600, the reading section 602 reads the recording/reproduction parameter for eight times speed (×8 speed) from the sector 408, which is previously allocated to correspond to a maximum performance condition indicating a maximum performance of the recording/reproduction apparatus 600 (e.g., recording/reproduction condition for 16 times speed (×16 speed)), among the sectors 404 to 411 included in the optical disc 101.

The reading section 602 may read one of the recording/reproduction parameters from at least one of the sectors 404 to 411 in the optical disc 101.

The recording/reproduction section 603 performs a recording operation or a reproduction operation for the optical disc in accordance with the read recording/reproduction parameter.

### 3. Recording/Reproduction Method

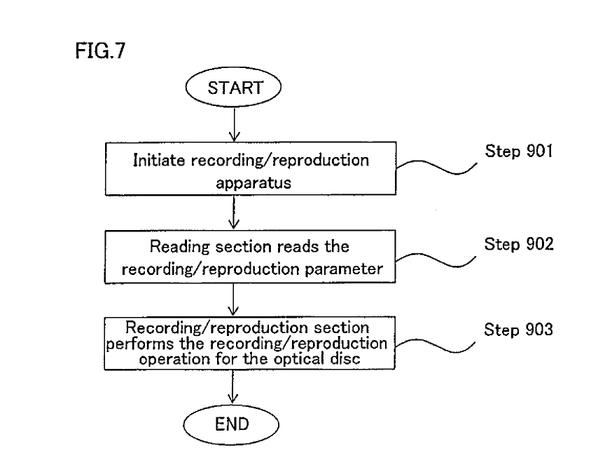

FIG. 7 shows a recording/reproduction procedure according to an embodiment of the present invention.

Hereinafter, the recording/reproduction procedure according to an embodiment of the present invention will be described step by step with reference to FIGS. 4, 6 and 7.

Step 901: The recording/reproduction apparatus 600 is initiated in response to an input from the outside of the recording/reproduction apparatus 600.

Step 902: In response to the initiation of the recording/reproduction apparatus 600, the reading section 602 reads at least one of a plurality of recording/reproduction parameters from any of the sectors 404 to 411 included in the optical disc 101 which is previously allocated to correspond to a maximum performance condition indicating a maximum performance of the recording/reproduction apparatus 600.

Step 903: The recording/reproduction section 603 performs a recording operation or a reproduction operation for the optical disc in accordance with the read recording/reproduction parameter.

After the recording operation or the reproduction operation is performed for the optical disc, the processing is completed.

Thus, the recording/reproduction procedure according to an embodiment of the present invention has been described step by step with reference to FIGS. 4, 6 and 7.

As described above with reference to FIGS. 4, 6 and 7, according to an embodiment of the present invention, it is possible to always keep the time required for reading the recording/reproduction condition constant, by combining an optical disc in which data can be recorded under a plurality of recording/reproduction conditions (e.g., a transfer rate) and an apparatus capable of performing a recording operation or a reproduction operation under a plurality of recording/reproduction conditions (e.g., a transfer rate).

Hereinafter, specific examples 1 to 3 will be described with reference to FIGS. 4 and 6.

### 4. EXAMPLE 1

In this example, a case where a recording/reproduction apparatus corresponding to one times speed (×1 speed) to two times speed (×2 speed) performs an operation at two times speed (×2 speed) will be described.

In Example 1, the recording/reproduction apparatus reads a recording/reproduction parameter from the sector 405 in order to perform the recording/reproduction operation at two times speed (×2 speed). In this case, it is possible to always read the recording/reproduction parameter for two time speed (×2 speed) regardless of the optical discs 401 to 403. Accordingly, the recording/reproduction apparatus corresponding to one times speed (×1 speed) to two times speed (×2 speed) can immediately perform a recording operation or a reproduction operation for the optical disc by referring to the recording/reproduction parameter.

### 5. EXAMPLE 2

In this example, a case where a recording/reproduction apparatus corresponding to one times speed (×1 speed) to 16 times speed (×16 speed) performs an operation at 16 times speed (×16 speed) will be described.

In Example 2, the recording/reproduction apparatus reads a recording/reproduction parameter from the sector 408 in order to perform the recording/reproduction operation at 16 times speed (×16 speed).

In the sector 408 of the optical disc 403 corresponding to two times speed (×2 speed) to 16 times speed (×16 speed), a recording/reproduction parameter for performing the recording/reproduction operation at 16 times speed (×16 speed) is recorded. Accordingly, the recording/reproduction apparatus corresponding to one times speed (×1 speed) to 16 times speed (×16 speed) can perform a recording operation or a reproduction operation for the optical disc 403 by referring to the recording/reproduction parameter.

In the optical disc 401 corresponding to one times speed (×1 speed) to two times speed (×2 speed) and the optical disc 402 corresponding to one times speed (×1 speed) to eight times speed (×8 speed), it is possible to obtain advantages which have not been provided conventionally.

In Example 2, the recording/reproduction apparatus reads the recording/reproduction parameter from the sector 408 of the optical disc 401 corresponding to one times speed (×1 speed) to two times speed (×2 speed) in order to perform the recording/reproduction operation at the 16 times speed (×16 speed). The recording/reproduction parameter for two times speed (×2 speed) is recorded in the sector 408 of the optical disc 401 The recording/reproduction parameter for two times speed (×2 speed) is a recording/reproduction parameter, which is closest in value to a recording/reproduction parameter to be read for performing the recording/reproduction operation at 16 times speed (×16 speed) by the recording/reproduction apparatus, among the recording/reproduction parameters for the recording/reproduction conditions corresponding to the optical disc 401. The recording/reproduction apparatus can perform the recording/reproduction operation at one times speed (×1 speed) to 16 times speed (×16 speed). Accordingly, it is possible to immediately perform the recording/reproduction operation for the optical disc 401 by referring to the recording/reproduction parameter.

The recording/reproduction apparatus reads the recording/reproduction parameter from the sector 408 of the optical disc 402 corresponding to one times speed (×1 speed) to eight times speed (×8 speed) in order to perform the recording/reproduction operation at the 16 times speed (×16 speed). The recording/reproduction parameter for eight times speed (×8 speed) is recorded in the sector 408 of the optical disc 402. The recording/reproduction parameter for eight times speed (×8 speed) is a recording/reproduction parameter, which is closest in value to a recording/reproduction parameter to be read for performing the recording/reproduction operation at 16 times speed (×16 speed) by the recording/reproduction apparatus, among the recording/reproduction parameters for the recording/reproduction conditions corresponding to the optical disc 402. The recording/reproduction apparatus can perform the recording/reproduction operation at one times speed (×1 speed) to 16 times speed (×16 speed). Accordingly, it is possible to immediately perform the recording/reproduction operation for the optical disc 402 by referring to the recording/reproduction parameter.

### 6. EXAMPLE 3

In this example, a case where a recording/reproduction apparatus corresponding to one times speed (×1 speed) to 16 times speed (×16 speed) performs an operation at one times speed (×1 speed) will be described.

In Example 3, the recording/reproduction apparatus reads a recording/reproduction parameter from the sector 404 in order to perform the recording/reproduction operation at one times speed (×1 speed). In the sector, 404 of the optical disc 401 and the sector 404 of the optical disc 402, a recording/reproduction parameter for one times speed (×1 speed) is recorded. Accordingly, the recording/reproduction apparatus corresponding to one times speed (×1 speed) to 16 times speed (×16 speed) can immediately initiate the recording/reproduction operation. Although the optical disc 403 does not correspond to the recording/reproduction operation at one times speed (×1 speed), the recording/reproduction condition for two times speed (×2 speed) which is closest in value to the recording/reproduction condition for one times speed (×1 speed) is recorded on the optical disc 403. Accordingly, the recording/reproduction apparatus corresponding to one times speed (×1 speed) to 16 times speed (×16 speed) can immediately initiate the recording/reproduction operation.

According to the present invention, in any combination of recording/reproduction apparatuses and optical discs, it Is possible to always read the most appropriate recording/reproduction condition in the combination of the apparatus and the optical disc by a single operation for reading the recording/reproduction parameter.

The embodiments of the present invention have been described with reference to FIGS. 1 to 7.

The present invention is not intended to limit the scope of the invention to the embodiments described above. Various changes can be made to the present invention within the scope of the invention. For example, in the embodiment described above, the recording/reproduction speed (the transfer rate) has been referred to as an example of the recording/reproduction condition. However, the recording/reproduction condition is not limited to this example. The recording/reproduction condition may be a recording linear density, for example. In a case where the recording/reproduction condition is a recording linear density, a recording/reproduction parameter regarding the recording linear-density is recorded in a plurality of sectors. Further, in the embodiment described above, an example of CLV mode where a transfer rate is kept to be constant has been described. However, it is possible to apply a rotating speed in a CAV mode where the optical disc is accessed at a constant rotating speed, for example.

In this manner, in the case where the recording/reproduction apparatus performs the recording/reproduction operation for the same optical disc under a plurality of recording/reproduction conditions, it is possible to obtain advantages similar to the advantages described above.

In the embodiment of the present invention, the use of a transfer rate for recording/reproducing data for the optical disc has been described. However, the present invention is not limited to the use of a transfer rate for recording/reproducing data for the optical disc. For example, the use of a transfer rate for recording data in the optical disc and the use of a transfer rate for reproducing data from the optical disc should be included within the scope of the present invention. As long as a transfer rate for accessing the optical disc is used, the used of the transfer rate should be included within the scope of the present invention.

For example, in a case where a transfer rate for accessing the optical disc is used, the recording/reproduction apparatus 600 functions as an access apparatus. The recording/reproduction section 603 functions as an access section. In this case, the access section accesses the optical disc in accordance with the read recording/reproduction parameter.

As described above, the present invention is exemplified by the use of its preferred embodiments. However, the present invention should not be interpreted solely based on the embodiments described above. It is understood that the scope of the present invention should be interpreted solely based on the claims. It is also understood that those skilled in the art can implement equivalent scope of technology, based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

For example, the following items 1 to 4 are also included within the scope of the present invention.

Item 1. An access apparatus for accessing an optical disc including a plurality of areas which are previously allocated to correspond to a plurality of conditions,

wherein a plurality of parameters for providing a method for accessing the optical disc under the plurality of conditions are recorded on the plurality of areas,

the access apparatus comprising:

an initiating section for initiating the access apparatus; and

a reading section for reading at least one of the plurality of parameters from any of the plurality of areas which is previously allocated to correspond to a maximum performance condition indicating a maximum performance of the access apparatus, in response to the initiation of the access apparatus.

Item 2. An access apparatus according to Item 1, further comprising an access section for accessing the optical disc using an access method provided by the read at least one parameter.

Item 3. An access apparatus according to Item 1, wherein the plurality of areas include at least one first area, which Is previously allocated to correspond to at least one first condition under which the optical disc can be accessed, among the plurality of conditions, and at least one second area, which is previously allocated to correspond to at least one second condition under which the optical disc cannot be accessed, among the plurality of conditions, and

a plurality of first parameters for providing a method for accessing the optical disc under the at least one first condition are recorded on the at least one first area and the at least one second area.

Item 4. An access method for accessing an optical disc including a plurality of areas which are previously allocated to correspond to a plurality of conditions,

wherein a plurality of parameters for providing a method for accessing the optical disc under the plurality of conditions are recorded in the plurality of areas,

the access method comprising the steps of:

initiating an access apparatus; and

reading at least one of the plurality of parameters from any of the plurality of areas which is previously allocated to correspond to a maximum performance condition indicating a maximum performance of the access apparatus, in response to the initiation of the access apparatus.

### INDUSTRIAL APPLICABILITY

According to the optical disc according to the present invention, a plurality of first parameters for providing a method for accessing the optical disc under at least one first condition that the optical disc can be accessed is recorded in at least one second area which is previously allocated to correspond to at least one second condition that the optical disc cannot be accessed. Accordingly, when the access apparatus accesses the second area, it is possible to obtain the first parameter from the second area without moving from the second area to the first area to obtain the first parameter at the first area. As a result, an access apparatus can obtain the first parameter in a short amount of time.

According to the present invention, it is possible to obtain an excellent effect that the time required for reading the recording/reproduction condition can be always kept constant for any combination of optical discs in which data can be recorded under a plurality of recording/reproduction conditions and apparatuses capable of performing a recording/reproduction operation under a plurality of recording/reproduction conditions.

1. An optical disc comprising a plurality of areas which are previously allocated to correspond to a plurality of conditions,
wherein the plurality of areas include:
at least one first area, which is previously allocated to correspond to at least one first condition under which the optical disc can be accessed, among the plurality of conditions; and
at least one second area, which is previously allocated to correspond to at least one second condition under which the optical disc cannot be accessed, among the plurality of conditions, and
a plurality of first parameters for providing a method for accessing the optical disc under the at least one first condition are recorded on the at least one first area and the at least one second area.

2. An optical disc according to claim 1, wherein one of the plurality of the first parameters corresponding to each of the at least one first area is recorded on each of the at least one first area.

3. An optical disc according to claim 1, wherein one of the plurality of first parameters, which is closest in value to a plurality of second parameters for providing a method for accessing the optical disc under the at least one second condition, is recorded on the at least one second area.

4. An optical disc according to claim 1, wherein the optical disc includes at least one recording layer,
each of the at least one recording layer include the at least one first area and the at least one second area, and
a plurality of third parameters for providing a method for accessing each of the at least one recording layer under the at least one first condition are recorded on the at least one first area and the at least one second area.

5. An optical disc according to claim 1, wherein the plurality of conditions include a condition regarding a speed at which the optical disc is accessed.

6. An access apparatus for accessing an optical disc including a plurality of areas which are previously allocated to correspond to a plurality of conditions,
wherein the plurality of areas include at least one first area, which is previously allocated to correspond to at least one first condition under which the optical disc can be accessed, among the plurality of conditions, and at least one second area, which is previously al-located to correspond to at least one second condition under which the optical disc cannot be accessed, among the plurality of conditions, and
a plurality of first parameters for providing a method for accessing the optical disc under the at least one first condition are recorded on the at least one first area and the at least one second area,
the access apparatus comprising:
a reading section for reading at least one of the plurality of first parameters from at least one of the at least one first area and the at least one second area; and
an access section for accessing the optical disc using an accessing method provided by the read at least one first parameter.

7. An access apparatus according to claim 6, wherein the reading section reads the at least one first parameter from at least one of the at least one second area.

8. An access method of accessing an optical disc including a plurality of areas which are previously allocated to correspond to a plurality of conditions,
wherein the plurality of areas include at least one first area, which is previously allocated to correspond to at least one first condition under which the optical disc can be accessed, among the plurality of conditions, and at least one second area, which is previously allocated to correspond to at least one second condition under which the optical disc cannot be accessed, among the plurality of conditions, and
a plurality of first parameters for providing a method for accessing the optical disc under the at least one first condition are recorded on the at least one first area and the at least one second area,
the access method comprising the steps of:
reading at least one of the first parameters from at least one of the at least one first area and the at least one second area; and
accessing the optical disc using an access method provided by the read at least one first parameter.

9. An access apparatus for accessing an optical disc including a plurality of areas which are previously allocated to correspond to a plurality of conditions,
wherein a plurality of parameters for providing a method for accessing the optical disc under the plurality of conditions are recorded on the plurality of areas,
the access apparatus comprising:
an initiating section for initiating the access apparatus; and
a reading section for reading at least one of the plurality of parameters from any of the plurality of areas which is previously allocated to correspond to a maximum performance condition indicating a maximum performance of the access apparatus, in response to the initiation of the access apparatus.

10. An access apparatus according to claim 9, further comprising an access section for accessing the optical disc using an access method provided by the read at least one parameter.

11. An access apparatus according to claim 9, wherein the plurality of areas include at least one first area, which is previously allocated to correspond to at least one first condition under which the optical disc can be accessed, among the plurality of conditions, and at least one second area, which is previously allocated to correspond to at least one second condition under which the optical disc cannot be accessed, among the plurality of conditions, and
a plurality of first parameters for providing a method for accessing the optical disc under the at least one first condition are recorded on the at least one first area and the at least one second area.

12. An access method for accessing an optical disc including a plurality of areas which are previously allocated to correspond to a plurality of conditions,
wherein a plurality of parameters for providing a method for accessing the optical disc under the plurality of conditions are recorded in the plurality of areas,
the access method comprising the steps of:
initiating an access apparatus; and
reading at least one of the plurality of parameters from any of the plurality of areas which is previously allocated to correspond to a maximum performance condition indicating a maximum performance of the access apparatus, in response to the initiation of the access apparatus.
